(19) United States
(12) Patent Application Publication
(10) Pub. No.: US 2026/0214338 A1
(43) Pub. Date: Jul. 23, 2026

(54) IMAGING DEVICE AND ZOOM METHOD THEREOF

(71) Applicant: MEDIATEK INC., Hsinchu City (TW)

(72) Inventors: Chi-Cheng JU, Hsinchu City (TW); Yu-Chang HUANG, Hsinchu City (TW); Yan-Shao LIU, Hsinchu City (TW); Kai WEI, Hsinchu City (TW); Kai-Chieh CHUANG, Hsinchu City (TW)

(21) Appl. No.: 19/452,605

(22) Filed: Jan. 19, 2026

Related U.S. Application Data
(60) Provisional application No. 63/748,503, filed on Jan. 23, 2025.

(51) Int. Cl. H04N 23/69; H04N 23/62; H04N 23/63

(52) U.S. Cl. CPC H04N 23/69; H04N 23/62; H04N 23/63

(57) ABSTRACT

An imaging device and zoom method thereof are provided. The zoom method includes: obtaining a first zoom factor based on a user setting operation; acquiring a raw image; determining a zoom factor variable based on the first zoom factor and the user setting operation, to generate a second zoom factor; cropping the raw image according to the second zoom factor to generate a first image; acquiring an updated first zoom factor; in a case where an absolute value of a difference between the updated first zoom factor and the second zoom factor is greater than a preset value, cropping the first image according to the updated first zoom factor to generate a second image; and displaying the second image.

### CROSS-REFERENCE TO RELATED APPLICATION

This application is a continuation application of U.S. Provisional Patent Application No. 63/748,503 filed on Jan. 23, 2025, which is incorporated herein by reference in its entirety.

### TECHNICAL FIELD

The present disclosure relates to the technical field of imaging technologies, in particularly relates to an imaging device and a zoom method thereof.

### BACKGROUND

During a zoom process of an imaging device, users expect the image displayed on the screen of the imaging device to respond in real-time with the zoom level, while the center position and overall brightness of the image remain stable without distortion. However, the zoom process of existing imaging devices has inherent latency from the Application Processor (AP) issuing a zoom request to the final image display. The latency may result in a lack of synchronization between the screen display and the user's operations when the user performs zooming, which may seriously affect the user experience.

In summary, the related technologies are unable to achieve rapid zoom response. There is an urgent need in the art for a novel zoom method.

### SUMMARY

According to a first aspect of the present disclosure, a zoom method for an imaging device is provided. The zoom method includes: obtaining a first zoom factor based on a user setting operation; acquiring a raw image; determining a zoom factor variable based on the first zoom factor and the user setting operation, to generate a second zoom factor; cropping the raw image according to the second zoom factor to generate a first image; acquiring an updated first zoom factor; in a case where an absolute value of a difference between the updated first zoom factor and the second zoom factor is greater than a preset value, cropping the first image according to the updated first zoom factor to generate a second image; and displaying the second image.

According to a second aspect of the present disclosure, an imaging device may be provided. The imaging device may include an imaging sensor, an image signal processor, an application processor, and a display module communicatively connected. The application processor is configured to: obtain a first zoom factor based on a user setting operation; and determine a zoom factor variable based on the first zoom factor and the user setting operation, to generate a second zoom factor. The imaging sensor is configured to acquire a raw image. The image signal processor is configured to: crop the raw image according to the second zoom factor to generate a first image. The application processor is further configured to: acquire an updated first zoom factor; and in a case where an absolute value of a difference between the updated first zoom factor and the second zoom factor is greater than a preset value, crop the first image according to the updated first zoom factor to generate a second image. The display module is configured to: display the second image.

According to a third aspect of the present disclosure, an imaging device may be provided. The imaging device may include a memory and a processor. The memory may store a program code. The program code, when executed by the processor, enables the imaging device to perform a zoom method. The zoom method may include: obtaining a first zoom factor based on a user setting operation; acquiring a raw image; determining a zoom factor variable based on the first zoom factor and the user setting operation, to generate a second zoom factor; cropping the raw image according to the second zoom factor to generate a first image; acquiring an updated first zoom factor; in a case where an absolute value of a difference between the updated first zoom factor and the second zoom factor is greater than a preset value, cropping the first image according to the updated first zoom factor to generate a second image; and, displaying the second image.

### BRIEF DESCRIPTION OF THE DRAWINGS

In order to more clearly illustrate technical solutions in the present disclosure, the drawings required in the description of the embodiments will be briefly introduced below. Obviously, the drawings in the following description are only some embodiments of the present disclosure. For those of ordinary skills in the art, other drawings could be obtained based on these drawings without creative efforts and should fall within the scope of the present disclosure. Among the drawings:

FIG. 1 is a schematic structural view of an imaging device according to an embodiment of the present disclosure.

FIG. 2 is a timing diagram of a zoom process of an imaging device.

FIG. 3 is a timing diagram of an image output process of the imaging device in the related art.

FIG. 4 is a schematic flowchart of a zoom method for the imaging device in the related art.

FIG. 5 is a schematic diagram of an image data flow in the zoom method of the imaging device in the related art.

FIG. 6 is a flowchart of a zoom method for the imaging device according to an embodiment of the present disclosure.

FIG. 7 is a schematic diagram of a zoom bar.

FIG. 8 is a schematic diagram of a finger pinching operation.

FIG. 9 is a flowchart of a process of generating the second zoom factor.

FIG. 10 is a flowchart of a process of determining the zoom direction.

FIG. 11 is a flowchart for determining the zoom factor variable according to an embodiment of the present disclosure.

FIG. 12 is a schematic flowchart of a zoom method for the imaging device according to an embodiment of the present disclosure.

FIG. 13 is a schematic diagram of the image data flow in the zoom method of the imaging device according to an embodiment of the present disclosure.

FIG. 14 is a schematic diagram of an image display latency issue when a user continuously performs a zoom-in operation by sliding the zoom bar.

FIG. 15 is a schematic diagram of the zoom method according to an embodiment of the present disclosure in a case where the user continuously performs the zoom-in operation by sliding the zoom bar.

FIG. 16 is a relationship curve diagram of finger swipe distance and zoom factor in the pinch-to-zoom scenario.

FIG. 17 is a processing flowchart for converting a user's finger pinch gesture into a zoom factor according to an embodiment of the present disclosure.

FIG. 18 is a schematic diagram of the image display latency issue when a user performs a zoom-in operation via pinch-to-zoom.

FIG. 19 is a schematic diagram of the zoom method provided according to an embodiment of the present disclosure when a user continuously performs a zoom-in operation via pinch-to-zoom.

FIG. 20 is a schematic structural diagram of an imaging device according to an embodiment of the present disclosure.

### DETAILED DESCRIPTION

Technical solutions in embodiments of the present disclosure will be described clearly and thoroughly in connection with accompanying drawings of the embodiments of the present disclosure in the following. It should be appreciated that, the specific embodiments described herein are for the purpose of explaining the present application only and but not for limiting it. It should also be noted that, for ease of description, the accompanying drawings show only part, but not all, of the structures relevant to the present disclosure. All other embodiments by a person of ordinary skills in the art based on embodiments of the present disclosure without creative efforts should all be within the protection scope of the present disclosure.

The terms “first” and “second” and the like in the present disclosure are used for distinguishing between different items and not for describing a particular sequence. In addition, the terms “include”, “comprise” and any variations thereof are intended to cover non-exclusive inclusion. For example, a process, a method, a system, a product, or a device that includes a series of operations or units is not limited to the listed operations or units, but optionally includes unlisted operations or units, or optionally also includes other operations or units inherent to these processes, methods, products or devices.

Reference to “embodiments” herein means that a specific feature, structure, or characteristic described in conjunction with the embodiments may be included in at least one embodiment of the present disclosure. The appearance of this phrase in various locations in the specification does not necessarily refer to the same embodiment, nor is it an independent or alternative embodiment mutually exclusive with other embodiments. Those skilled in the art may explicitly and implicitly understand that, the embodiments described herein may be combined with other embodiments.

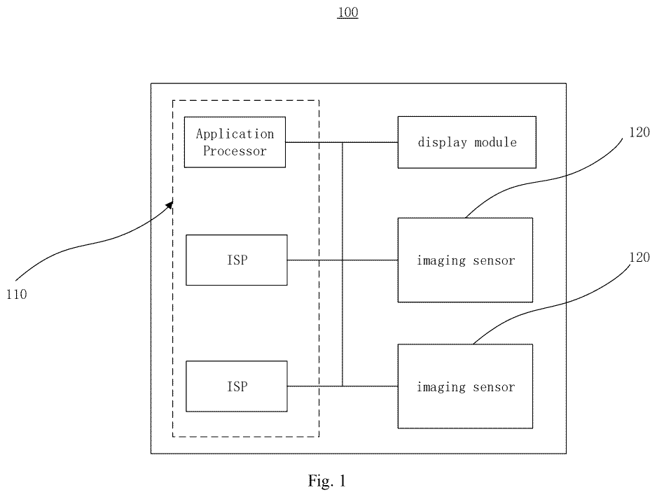

As illustrated in FIG. 1, FIG. 1 is a schematic structural view of an imaging device according to some embodiments of the present disclosure. The imaging device 100 may be, for example, a mobile phone, a smart phone, a tablet computer, a digital camera, or other such devices, which is not limited herein.

As illustrated in FIG. 1, the imaging device 100 may include a processor 110 and at least one imaging sensor 120. The processor 110 may be configured to be electrically connected to each of the at least one imaging sensor 120. The imaging sensor 120 may be, for example, a CMOS (complementary metal-oxide-semiconductor) sensor, a charge coupled device (CCD), or the like. The number of the imaging sensors is not limited in the present disclosure. Different imaging sensors 120 may include, for example, different focal length ranges.

As illustrated in FIG. 1, the processor 110 may be, for example, an application processor (AP) or an image signal processor (ISP). The imaging device may be provided with at least one application processor. The imaging device may also, for example, be provided with one ISP for each imaging sensor. The ISP may be electrically connected to the matched imaging sensor. Each of a plurality of ISPs may be connected to the application processor.

In some embodiments, the processor may be configured to receive user hints (also referred to as user instructions) for imaging sensor stream on, imaging sensor stream off or imaging parameter adjustment, etc. The imaging parameter of the imaging sensor may include zoom factor. For example, when the user commands to take a photo, adjust a focal length, or transit a shooting mode (such as a night scene mode, a portrait mode), the processor may receive the user hint, parses the user's requirements, determines to enable the data stream on of the imaging sensor, adjusts imaging parameters of the imaging sensor, or the like.

The AP may be a core computing unit of the imaging device. For example, the AP may be used to receive user operation instructions, generate zoom requests, coordinate the work of various hardware modules, or the like.

In some embodiments, the ISP may be a dedicated hardware module for image signal processing. In some embodiments, the ISP may be configured to read out and perform processing such as format conversion, noise reduction, and cropping on the raw images captured by the imaging sensor, and output the image data that may be further processed. For example, the ISP may convert the raw images in RAW format into images in YUV format, which is not limited herein.

Before describing technical schemes of the present disclosure in detail, for convenience of understanding, the following several concepts mentioned in the description may be briefed first.

### Focal Length

The “focal length” may be generally measured in millimeters (mm), and may refer to a distance from the point where light converges inside the camera to the imaging sensor when the focus is at its sharpest. The “focal length” here may also be referred to as a physical length. In general, the longer the focal length, the smaller a visible scene range of the camera, and the narrower the viewing angle. Conversely, the shorter the focal length, the wider the viewing angle.

In scenarios where the imaging device 100 is a smart phone, a tablet, or the like, the internal space is very valuable, the camera is very small and have tiny sensor. The “focal length” of the camera may generally refer to an equivalent value of a 35 mm format sensor, i.e., the 35 mm equivalent focal length, which may be briefed as an equivalent focal length.

The 35 mm equivalent focal length of the camera may refer to, the focal length of the lens that would be needed on a camera equipped with a 35 mm full-frame sensor, so as to obtain the same shooting view angle and image as the current camera with its specific physical focal length.

### Focal Length and View Angle

The view angle may refer to a range of a scene that can be seen through a camera, and may be generally measured in degrees. As mentioned above, the focal length is closely related to the “view angle”. The shorter the focal length of a camera, the wider the view angle, and the more of the scene that can be captured. The longer the focal length, the narrower the view angle, and the more pronounced a magnification effect of the subject being photographed.

### Equivalent View Angle Magnification and Zoom Factor

On a screen or preview interface of the imaging device 100, the focal length may often be expressed in the format of a number followed by the letter “X”, such as 1X, 2X, 1.6X, etc. The number in this format may represent the equivalent view angle magnification. The equivalent view angle magnification may also be referred to as a zoom factor, magnification identifier, or zoom value. 1X may correspond to a reference equivalent focal length of a camera (usually the primary camera), such as a focal length of 35 mm. NX may indicate that the view angle is switched to 1/N of the 1X state, and the equivalent focal length is switched to N times that of the 1X state. In other words, NX may indicate that the view angle is magnified to N times the original view angle, where N is a real number.

The “X” on the preview interface 110 is a “user-friendly expression” of the focal length. Magnifications other than 1X are the results of view angle scaling after the focal length is scaled proportionally based on a reference focal length. The “X” expression not only reflects the optical characteristics of the focal length but also facilitate the user to quickly understand the scaling degree of the shooting range.

In the present disclosure, the focal length may be expressed in the form of focal length (physical focal length or equivalent focal length) or equivalent view angle magnification (also referred to as zoom factor).

The following section of the description would describe the technical problems and corresponding technical solutions of the present disclosure in conjunction with the accompanying drawings.

During the zoom process of the imaging device, users may expect the screen of the imaging device to change according to different zoom levels, and there should be no change in brightness at the screen center or in the overall brightness of the screen. With proliferation of multi-camera smartphones, users may expect the screen to respond in real-time to swipe gestures or to rotation of a screen dial. The faster the response, the more immediate the screen's reaction. In addition to real-time responsiveness, users may also expect a smooth visual transition when swiping the dial, without any abrupt changes.

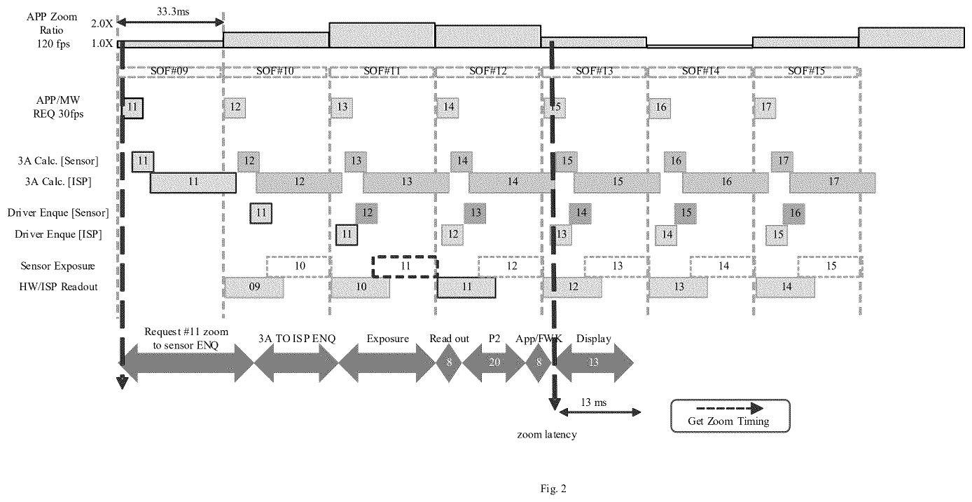

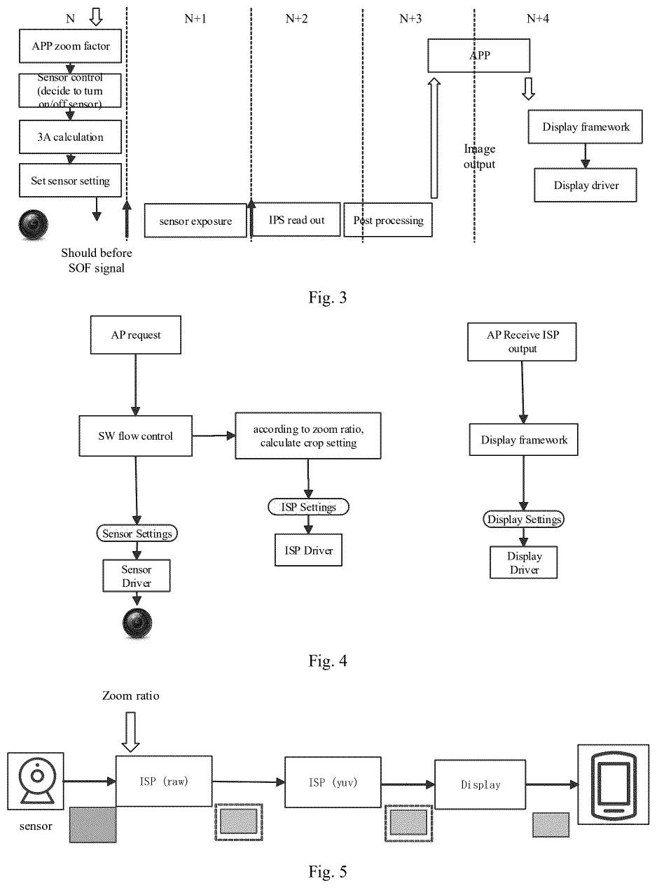

However, as mentioned above, the zoom process of the imaging devices has inherent latency from the AP issuing a zoom request to the final image display. As illustrated in FIG. 2 and FIG. 3, FIG. 2 is a timing diagram of the zoom process of an imaging device in the related art, and FIG. 3 is another timing diagram of the image output process of the imaging device in the related art.

In the example of FIG. 2, the user may perform touch-based operations on the touchscreen of the imaging device. The touchscreen of the imaging device may acquire user operations at a sampling frame rate of 120 frames per second, i.e., APP Zoom factor 120 fps as illustrated in FIG. 2, to obtain the zoom factor matching with the user's operations. The APP may be an application program running on the AP, such as a camera application. By way of example, the imaging device may perform display at a frame rate of 30 fps, requiring the display of 30 frames of images per second. In the art, a “frame” may serve as the basic unit for screen image display, and “frame rate” (Frames Per Second, fps) may refer to the number of frames displayed per second. A single frame interval corresponding to 30 fps is approximately 33.3 milliseconds. Correspondingly, the APP or MW may issue the shooting requests at a frame rate of 30 fps. Middleware (MW) is a core software layer in the imaging device that connects the APP with underlying hardware modules (e.g., sensors, ISP, display drivers). Specifically, the middleware may reside between the application layer (APP/AP) and the Hardware Abstraction Layer (HAL), and may be responsible for parsing and encapsulating zoom requests, coordinating the scheduling of underlying hardware resources, controlling the timing of zoom request delivery, and ensuring timing synchronization and compatibility of instruction transmission.

SOF usually may refer to the moment when the exposure data of an image frame of the imaging sensor starts to be output. In FIG. 2, SOF (Start of Frame) is used as the time unit and synchronization reference signal. The time interval between two adjacent SOF signals may also be approximately 33.3 milliseconds. SOF #09 to SOF #15 in FIG. 2 mark the processing cycles of different image frames.

Taking the zoom request labeled Request #11 as an example, the APP issues Request #11 during the SOF #09 cycle. For example, when the user clicks the zoom bar, the app will send Request #11 based on the current zoom factor.

Subsequently, during the SOF #09 and SOF #10 cycles, Request #11 may trigger the 3A computation for the ISP and the imaging sensor respectively, to obtain configuration parameters. This 3A computation may be generally executed by the Hardware Abstraction Layer (HAL). 3A refers to Auto Focus (AF), auto exposure (AE) and auto white balance (AWB). For example, when the camera's HAL layer receives the AP request, it will first determine whether the zoom factor requires pre-opening of other sensors. Next, it will recalculate the 3A (AE, AWB) adjustments for sensor exposure based on the current environmental brightness.

After that, the sensor receives the configuration parameters and completes the Driver Enqueue during the SOF #10 cycle, while the ISP receives the configuration parameters and completes the Driver Enqueue during the SOF #11 cycle. In the Driver Enqueue process, the hardware driver may add the configured instructions to the pending execution queues of the sensor and the ISP respectively, waiting for an appropriate execution timing.

Next, the imaging sensor performs the exposure operation and captures a raw image during the SOF #11 cycle. At SOF #12, the ISP starts the raw image reading out operation, the duration of which depends on the sensor readout time. At this point, the ISP obtains the image result corresponding to Request #11. The ISP then performs post-processing (P2) such as format conversion and cropping on the raw images, with the post-processing taking around 20 ms. The ISP subsequently transmits the processed images to the APP or the Application Framework. The APP may for instance optimize the images. This optimization process may take roughly 8 ms. The APP then sends the images to the screen for display, this process that consumes about 13 ms.

In the example of FIG. 2, the APP issues the Request #11 at SOF #09, but the corresponding image is not displayed until SOF #13. The interval in between may amount to approximately 4 SOF cycles, corresponding to a delay of over 130 ms.

With further reference to FIG. 3, similar to FIG. 2, FIG. 3 illustrates the frame processing cycles starting from SOF. Specifically, FIG. 3 illustrates the frame processing cycles from N to N+4.

During frame processing cycle N, the AP issues a request including the zoom factor. The sensor control module determines whether it is necessary to turn on/off the sensor (e.g., whether camera switching is required), performs 3A parameter calculation, and delivers the calculated configuration parameters to the sensor. These operations need to be completed before the next SOF signal.

During the frame processing cycle N+1, the sensor performs sensor exposure. Specifically, based on the configuration parameters obtained in frame processing cycle N, the sensor executes the exposure operation after the SOF signal and captures the raw image.

During the frame processing cycle N+2, the ISP reads out the raw image captured by the imaging sensor after exposure, and performs basic processing such as format conversion and/or noise reduction.

During the frame processing cycle N+3, the ISP transmits the post-processed images to the AP. The AP receives the image data.

During the frame processing cycle N+4, the AP sends the images to the display framework. After processing by the display driver, the image is finally presented to the user on the screen.

As can be seen from FIG. 3, in the present embodiment, the entire zoom process spans at least 5 frame processing cycles.

As illustrated in FIG. 2 and FIG. 4, FIG. 4 is a schematic flowchart of a zoom method for the imaging device in the related art. As illustrated in FIG. 4, the AP issues a zoom request to trigger the zoom process. The zoom request may carry the current zoom factor. After receiving the AP request, the Software (SW) Flow Control module or the software layer may configure the imaging sensor parameters (i.e., sensor settings). The imaging device may also calculate the cropping parameters for ISP parameter configuration (ISP setting) based on the zoom factor contained in the AP request. For example, the software layer would convert this zoom factor into the active domain size of the sensor. This ISP setting will be applied to the ISP crop module. The imaging sensor parameters are sent to the sensor driver. The ISP parameters are sent to the ISP driver.

The imaging sensor captures the raw image. The ISP receives the cropping parameters calculated by the software flow control module. The ISP driver configures the ISP to complete the reading out, format conversion and processing operations of the raw image. The processing operation may include the ISP performing an image cropping operation based on the zoom factor in the AP request, which may correspond to the post-processing operation P2 illustrated in FIG. 2. The AP receives the cropped images output by the ISP. The display framework receives the images transmitted from the AP and performs display parameter configuration. The display parameters are transmitted to the display driver. Finally, the image is output by the display driver to the screen and presented to the user.

In FIG. 4, when the ISP outputs the image and sends it to the AP, the AP would not adjust the size of this image but will directly send it to the display for presentation.

As illustrated in FIG. 5, FIG. 5 is a schematic diagram of the image data flow in the zoom method of the imaging device in the related art. The imaging sensor captures the raw image. The ISP reads out the raw images in RAW format from the imaging sensor. The zoom factor contained in the zoom instruction that triggers the raw image capture is transmitted to the ISP. The ISP converts the RAW format into YUV format, and crops, based on this zoom factor, the images in YUV format. In FIG. 5, the region between the dashed box and the gray rectangle indicates the cropped region. The cropped images are output to the display module and presented on the screen.

Based on the above discussion of FIG. 2 to FIG. 5, taking a general scene as an example, the traditional approach is to crop based on the zoom factor at the time the request is issued by the AP. However, the entire camera flow involves capturing the image with the sensor, exposure, readout, post-processing, and finally displaying it on the screen. The overall software flow takes a period more than 130 ms, which results in a noticeable delay between the user's finger movement and the display update for the user.

To reduce the aforementioned latency and achieve optimal responsiveness, the present disclosure may perform cropping processing based on the user's current operation immediately before screen display. However, performing cropping at the final stage requires a sufficient field of view (FOV), thereby reserving adequate cropping margin for the cropping operation.

In some embodiments, after receiving a zoom request, the imaging sensor may adopt a full-size imaging mode to capture raw image of full size. This method may provide sufficient cropping margin, which can ensure image clarity and responsive flexibility. However, the post-processing of the raw image will significantly increase the power consumption of the imaging device, easily causing the device to heat up and shortening the continuous shooting time.

In some embodiments, after receiving a zoom request, the imaging sensor may adopt a full-FOV imaging mode corresponding to the screen size. The captured images need to undergo a process of downscaling and then upscaling. This method will affect the clarity of the finally displayed images.

In some embodiments, if the ISP performs cropping according to the zoom request that triggers the imaging sensor. In this way, no additional cropping margin may be available during the display stage, which in turn affects responsiveness.

In view of the above factors, the present disclosure dynamically adjusts the cropping margin by predicting user operations.

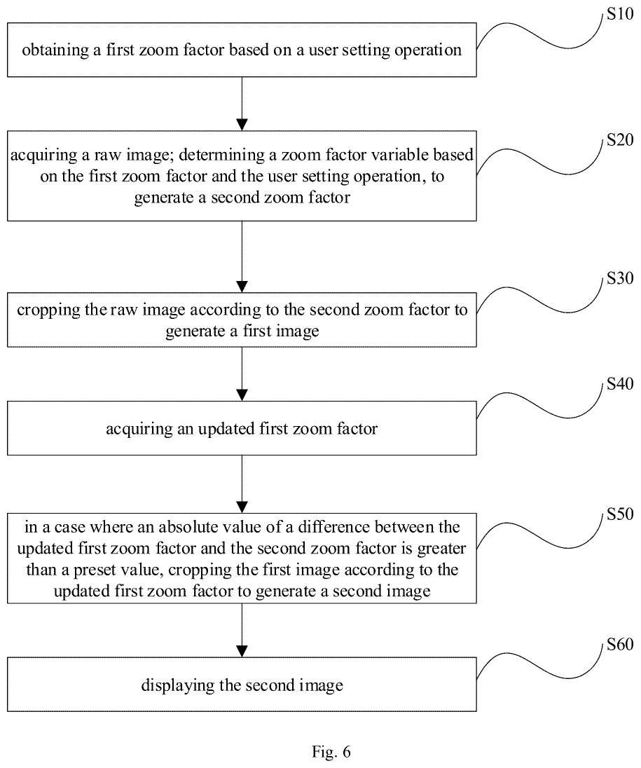

As illustrated in FIG. 6, FIG. 6 is a flowchart of a zoom method for the imaging device according to an embodiment of the present disclosure. The zoom method may include the operations as illustrated in FIG. 6 below.

The operation at block S10: obtaining a first zoom factor based on a user setting operation.

In some embodiments, the user setting operation includes any one of rotating a screen dial, sliding a zoom factor bar, or a gesture operation.

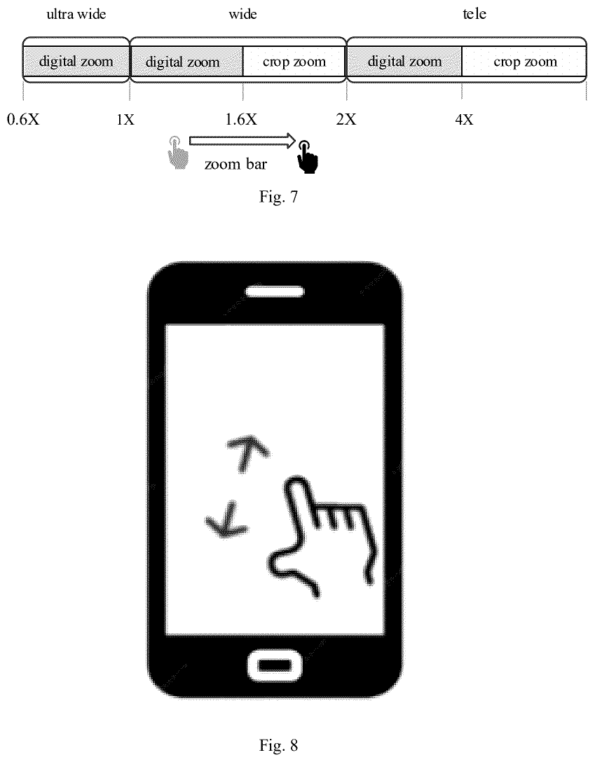

In some embodiments, as illustrated in FIG. 7, FIG. 7 is a schematic diagram of a zoom bar. The imaging device may be provided with a virtual zoom bar. The user setting operation may include sliding this zoom bar to adjust the zoom factor. As illustrated in FIG. 7, the imaging device may include multiple imaging sensors; FIG. 7 illustrates three of them by way of example and not limitation, specifically including an ultra-wide-angle sensor, a wide-angle sensor, and a telephoto sensor. Different imaging sensors correspond to different zoom factor ranges, and the user can slide the zoom bar (as indicated by the arrow) to switch and/or select the zoom factor. Different finger positions may match with different zoom factors, which is not limited herein.

In some embodiments, gesture operations may include, for example, finger pinching, which is not specifically limited in the embodiments of the present disclosure. FIG. 8 is a schematic diagram of a finger pinching operation. As illustrated in FIG. 8, the imaging device may be a cell phone. During the finger pinching operation, the user's fingers may slide in opposite directions (e.g., spreading apart or pinching together vertically) on the touch screen of the imaging device, triggering the imaging device to adjust the zoom factor to zoom in or out of the displayed frame.

In some embodiments, the imaging device may be provided with the screen dial. The user may rotate the screen dial to adjust the zoom factor.

In some embodiments, as discussed above, the touchscreen of the imaging device may acquire user operations at a certain sampling frame rate, so as to obtain the zoom factor matching with the user's operations.

The operation at block S20: acquiring a raw image; determining a zoom factor variable based on the first zoom factor and the user setting operation, to generate a second zoom factor.

In some embodiments, the imaging device, such as the software layer of the imaging device, may select the imaging sensor to be activated based on the zoom request and calculate 3A parameters for the imaging sensor and the ISP. The imaging sensor may receive these 3A parameters, and capture the raw image in full-size mode, full-FOV mode or other modes, which is not specifically limited in the embodiments of the present disclosure.

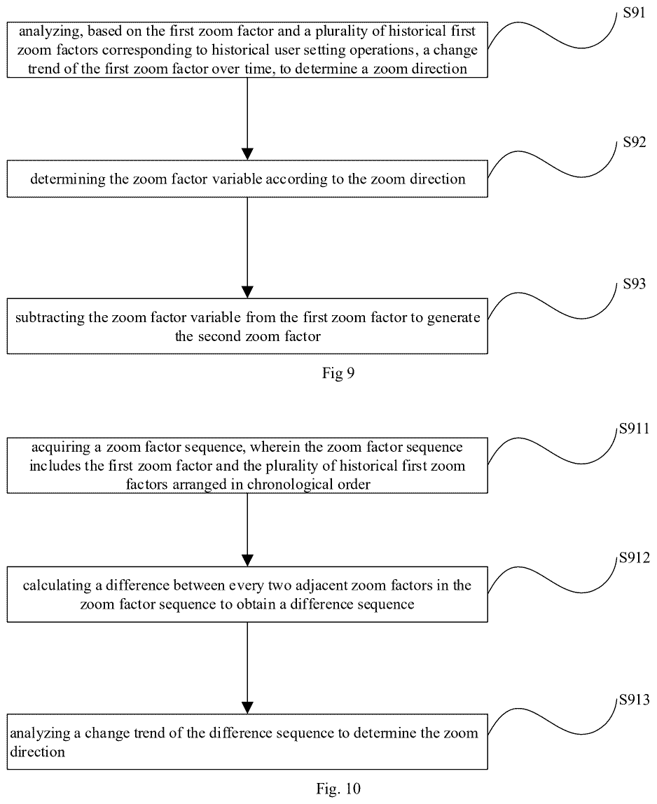

In some embodiments, as illustrated in FIG. 9, FIG. 9 is a flowchart of a process of generating the second zoom factor. The determining the zoom factor variable based on the first zoom factor and the user setting operation to generate the second zoom factor may include the operation as illustrated in FIG. 9.

The operation at block S91: analyzing, based on the first zoom factor and a plurality of historical first zoom factors corresponding to historical user setting operations, a change trend of the first zoom factor over time, to determine a zoom direction.

Specifically, Analyze the changes in zoom factor to determine the user's gesture trends.

In some embodiments, as illustrated in FIG. 10, FIG. 10 is a flowchart of a process of determining the zoom direction. The analyzing, based on the first zoom factor and the plurality of historical first zoom factors, the change trend of the first zoom factor over time, to determine the zoom direction includes the operations as illustrated in FIG. 10.

The operation at block S911: acquiring a zoom factor sequence, wherein the zoom factor sequence includes the first zoom factor and the plurality of historical first zoom factors arranged in chronological order.

In some embodiments, historical Zoom factors may be stored. For example, a data structure (such as an array or list) to store the most recent N zoom factors may be stored. N may be an integer greater than 1. These zoom factors may be sampled in the recent frames. Whenever a new zoom factor is received, add it to the data structure. If the data structure already has N data, remove the oldest one to keep the data structure always containing the latest N data. At this point, the new zoom factor may be referred to as the first zoom factor. The other zoom factors in the data structure may be referred to as the historical first zoom factors. In some embodiments, one zoom factor may also be stored at intervals of M, where M is an integer greater than 1.

Combined with FIG. 2 and with reference to Table 1, Table 1 shows an example of a table for storing the zoom factors.

TABLE 1

| Request number | Zoom factor |
|---|---|
| Request 11 | 0.6 |
| Request 12 | 0.8 |
| Request 13 | 1.0 |
| Request 14 | 1.1 |
| Request 15 | 1.1 |
| Request 16 | 0.8 |
| Request 17 | 0.7 |
| Request 18 | 0.6 |

As illustrated in Table 1, each time a new zoom request is sampled, its corresponding zoom factor is stored in the data structure. Currently, Table 1 stores the zoom factors corresponding to Requests 11 to 18. When a new Request 19 is received, since the table is fully occupied, the earliest Request 11 will be removed from the data structure and the new Request 19 will be added instead. These zoom factors may be arranged in chronological order, thereby forming the zoom factor sequence.

In some embodiments, the zoom factor sequence may take the form of an array, list, stack, or the like, and the present disclosure imposes no specific limitations thereon. For example, the zoom factor sequence may be denoted as

$${\{ {Z}_{i} \}}_{i = 1}^{N} ,$$

where Zᵢ represents the i-th zoom factor in the zoom factor sequence, i is a positive integer, and 1≤i≤N. Zᵢ and Zᵢ₊₁ are two zoom factor variables with adjacent sampling times.

The operation at block S912: calculating a difference between every two adjacent zoom factors in the zoom factor sequence to obtain a difference sequence.

In some embodiments, the difference between each pair of adjacent zoom factors in the zoom factor sequence may be calculated to obtain a set of change values. Specifically, the zoom factor diff=current request zoom factor−previous request.

For example, for the N zoom factors in the zoom factor sequence denoted as

$${\{ {Z}_{i} \}}_{i = 1}^{N} ,$$

the change values or differences would be calculated as: Δi=Zᵢ₊₁−Zᵢ. In other words, Δ₁=Z₂−Z₁, Δ₂=Z₃−Z₂, . . . , and so on. In this way, a difference sequence

$${\{ {Δ}_{i} \}}_{i = 1}^{N - 1}$$

may be obtained.

The operation at block S913: analyzing a change trend of the difference sequence to determine the zoom direction.

In some embodiments, for the zoom factor sequence denoted as

$${\{ {Z}_{i} \}}_{i = 1}^{N} ,$$

if the zoom factor diff Δᵢ>0, the zoom factor increases, the user may expect the FOV to narrow, then Δᵢ represents a zoom in case; if the zoom factor diff Δᵢ<0, the zoom factor decreases, the user may expect the FOV to widen, then Δᵢ represents a zoom out case; or, if the zoom factor diff Δᵢ=0, then Δᵢ represents stable zoom factor or a potential zoom direction change.

In some embodiments, for the zoom factor sequence denoted as

$${\{ {Z}_{i} \}}_{i = 1}^{N} ,$$

in a case where the most recent zoom factor difference value (e.g., Δ_{N-1}) is significantly greater than the previous zoom factor difference values, it is determined as a sudden gesture change, or this is a case of sudden change. In this case, the user is not likely to change the zoom direction.

In some embodiments, for the zoom factor sequence denoted as

$${\{ {Z}_{i} \}}_{i = 1}^{N} ,$$

in a case where the most recent zoom factor difference values are gradually decreasing, it is determined as a gradual gesture change, or this is a case of gradual change. In this case, the user may be about to adjust the zoom direction.

In some embodiments, referring to Table 2. Table 2 shows the specific results of trend determination corresponding to the zoom factors in the above-mentioned Table 1.

TABLE 2

| Zoom factor Difference | Difference Direction |
|---|---|
| N/A | Current |
| 0.8 − 0.6 = 0.2 | Zoom in |
| 1.0 − 0.8 = 0.2 | Zoom in |
| 1.1 − 1.0 = 0.1 | Zoom in (slow down) |
| 1.1 − 1.1 = 0 | May change direction |
| 0.8 − 1.1 = −0.3 | Zoom out |
| 0.7 − 0.8 = −0.1 | Zoom out |
| 0.6 − 0.7 = −0.1 | Zoom out |

If the zoom factor difference becomes increasingly greater, it indicates that the user is scrolling faster and will not change direction. If the zoom factor difference becomes smaller, it indicates that the user is scrolling slower and may stop scrolling or change direction. If the zoom factor difference is 0, it indicates that the user may change zoom direction.

In other words, the analyzing the change trend of the difference sequence to determine the zoom direction includes: in a case where differences in the difference sequence are positive and an absolute values of the differences increase or remain unchanged, determining the zoom direction as continuous zoom-in. and/or in a case where differences in the difference sequence are negative and the absolute values of the differences increase or remain unchanged, determining the zoom direction as continuous zoom-out, and/or in a case where the absolute values of the differences in the difference sequence gradually decreases or become zero, determining the zoom direction as a potential direction change.

The operation at block S92: determining the zoom factor variable according to the zoom direction.

The zoom factor variable may be adopted to adjust the cropping configuration parameters of the raw image read out from the imaging sensor. The primary cropping amount of the raw image may thus be adaptively regulated in accordance with the user's zoom direction, so that different margins are retained for the secondary cropping implemented prior to image display. Therefore, the zoom factor variable may be referred to as the margin. The primary cropping may for example be performed by the ISP. The secondary cropping may be performed by the AP.

When dynamically adjusting the image size, the following operations may be performed based on different zoom directions to ensure the best display effect of the image.

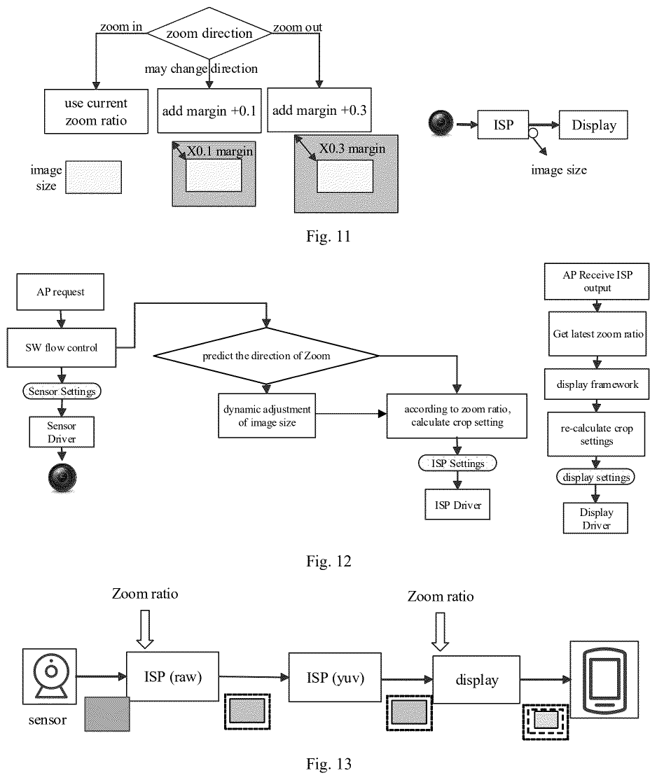

As illustrated in FIG. 11, FIG. 11 is a flowchart for determining the zoom factor variable according to an embodiment of the present disclosure. As illustrated in the right part of FIG. 11, the zoom factor variable or the margin may be configured to adjust the size of the image processed by the ISP.

First, the case of zoom-in direction. The original crop settings may be used. This helps maintain the details and clarity of the image, as zooming in is usually intended to enlarge specific areas of detail. In this case, the zoom factor variable may be 0.

Second, the case of possible change in direction. To proactively handle potential zoom out situations, increase the margin in advance (+0.1), thereby increasing the FOV of the image processed by the ISP. This provides more edge space when zooming out. In this case, the zoom factor variable may be greater than 0, such as 0.1. In this case, as illustrated in FIG. 11, the size of the image processed by the ISP is increased, thereby reserving more space for subsequent cropping by the AP.

Third, the case of Zoom Out Direction. Since the display end is at the final stage (3 frames behind), increase the margin in advance (the margin is for example 0.3). This ensures that there is enough edge space to display the image when zooming out. In this case, the zoom factor variable may be much greater, such as 0.3. In this case, as illustrated in FIG. 11, the size of the image processed by the ISP may be greater.

Through the above-mentioned dynamic adjustments, the best display effect of the image under different zoom directions may be assured, and prompt respond to changes in the zoom direction may be achieved.

It should be noted that the aforementioned zoom factor variables of 0.1 and 0.3 are merely examples and not limitations.

In some embodiments, the determining the zoom factor variable according to the zoom direction includes at least one of: in a case where the zoom direction is the continuous zoom-in, determining the zoom factor variable as a first variable; in a case where the zoom direction is the continuous zoom-out, determining the zoom factor variable as a second variable. and/or, in a case where the zoom direction is the potential direction change, determining the zoom factor variable as a third variable. The first variable is less than the third variable, and the third variable is less than the second variable.

In some embodiments, the first variable is 0; and/or, the second variable is 0.3; and/or, the third variable is 0.1.

The operation at block S93: subtracting the zoom factor variable from the first zoom factor to generate the second zoom factor.

In some embodiment, the specific implementation operation in the above-mentioned zoom in case may be: keeping the original crop settings without any additional adjustments. In this case, the zoom factor variable is 0, the first zoom factor may thus be equal to the second zoom factor.

The specific implementation operation in the Possible Change in Direction case may thus be: calculating the new margin value, wherein new margin=original margin+0.1. The crop settings may be updated to include the new margin.

The specific implementation operation in the Zoom Out case may thus be: Calculating the new margin value: new margin=original margin+0.3. The crop settings may be updated to include the new margin.

Since the margin is increased, the second zoom factor is correspondingly decreased.

The operation at block S30: cropping the raw image according to the second zoom factor to generate a first image.

In some embodiments, the imaging device includes the ISP. the cropping the raw image according to the second zoom factor to generate the first image includes: cropping, by the ISP, the raw image according to the second zoom factor to generate the first image.

The operation at block S40: acquiring an updated first zoom factor.

In some embodiments, the updated first zoom factor may be obtained based on the user's current setting operation. For example, the latest first zoom factor selected by the user through the setting operation may be directly acquired. When the user adjusts the zoom factor by sliding the zoom bar, the first zoom factor corresponding to their current finger position may be obtained. When the user adjusts the zoom factor through a gesture operation (such as pinch-to-zoom), the first zoom factor corresponding to their current gesture may be acquired. For the specific manner of obtaining the updated first zoom factor, reference may be made to the relevant description of step S10 above, which will not be repeated herein.

The operation at block S50: in a case where an absolute value of a difference between the updated first zoom factor and the second zoom factor is greater than a preset value, cropping the first image according to the updated first zoom factor to generate a second image.

In some embodiments, the imaging device further includes the AP. the cropping the first image according to the updated first zoom factor to generate the second image includes: performing secondary cropping, by the AP, the first image according to the updated first zoom factor to generate the second image.

In the present embodiment, the imaging device may calculate the difference between the updated first zoom factor and the second zoom factor that has been adjusted based on the user's zoom trend, and take the absolute value of the difference to obtain the absolute zoom factor difference. Subsequently, the absolute zoom factor difference may be compared with a preset value. Here, the preset value may also be referred as a preset threshold.

Herein, the preset threshold is a parameter preconfigured based on the device's hardware characteristics, image processing latency requirements, and user experience optimization objectives. For example, the preset threshold may be set to 0.1×zoom factor, and its specific value can be adaptively adjusted according to hardware parameters such as the sensor's field of view (FOV), image signal processor (ISP) processing performance, and application processor (AP) processing performance. The core function of this comparison operation is to determine whether the magnitude of the user's zoom operation change meets the threshold standard for triggering re-cropping, thereby avoiding frequent cropping caused by minor zoom fluctuations and further achieving a dynamic balance between response speed and processing efficiency.

If the calculated absolute zoom factor difference is greater than the aforementioned preset threshold, it indicates that the magnitude of the user's current zoom operation change is relatively great, and the first image obtained after primary cropping may no longer match the latest zoom requirement. At this point, the secondary cropping process may be triggered. The imaging device may perform the secondary cropping process on the first image based on the updated first zoom factor as the reference, and finally generates the second image. Through this secondary cropping process, the present disclosure may ensure real-time matching between image display and user operations, control the zoom latency within a single-frame level, and guarantee a smooth and non-latency visual experience for users during rapid zooming.

In some embodiments, if the absolute zoom factor difference is less than or equal to the preset threshold, it is determined that the first image after the primary cropping already meets the current display requirement, and the first image may be directly transmitted to the display module for rendering and output, so as to optimize image processing efficiency and reduce device power consumption.

The operation at block S60: displaying the second image.

In some embodiments, the imaging device further includes a display module. The displaying the second image includes: displaying the second image via the display module.

In some embodiments, the AP may send the second image to the display framework. After processing by the display driver, the second image may be finally presented to the user on the display module. The display module may also be referred to as the screen.

As illustrated in FIG. 4, FIG. 5, FIG. 12 and FIG. 13, FIG. 12 is a schematic flowchart of a zoom method for the imaging device according to an embodiment of the present disclosure, FIG. 13 is a schematic diagram of the image data flow in the zoom method of the imaging device according to an embodiment of the present disclosure.

Compared with FIG. 4 and FIG. 5, as illustrated in FIG. 12 and FIG. 13, in the technical solution of the present disclosure, the software layer may predict the zoom direction and dynamically adjust the image size based on the prediction result. Specifically, as described earlier, the system may calculate the second zoom factor by combining the predicted zoom direction and the first zoom factor issued by the AP request; then, the ISP parameters may be configured based on the second zoom factor, and the ISP may crop the raw image read out from the imaging sensor to generate the second image. After the AP receives the second image output by the ISP, it will obtain the latest first zoom factor, recalculate the cropping parameters according to this latest first zoom factor, and then perform a secondary cropping operation on the second image. This design not only enables the final image presented to the user to highly match the latest first zoom factor adjusted by the user, effectively reducing the response delay of the zoom operation; at the same time, the processing load of secondary cropping is relatively light, which may further reduce the power consumption of the imaging device.

In the present disclosure, at the final stage—immediately before the display refresh—the crop parameters are recalculated based on the current zoom factor. In this manner, the time latency between the user's operation and the screen response can be reduced to less than 70 ms, thereby achieving precise alignment between the screen response and the user's operation.

### Implementation 1:

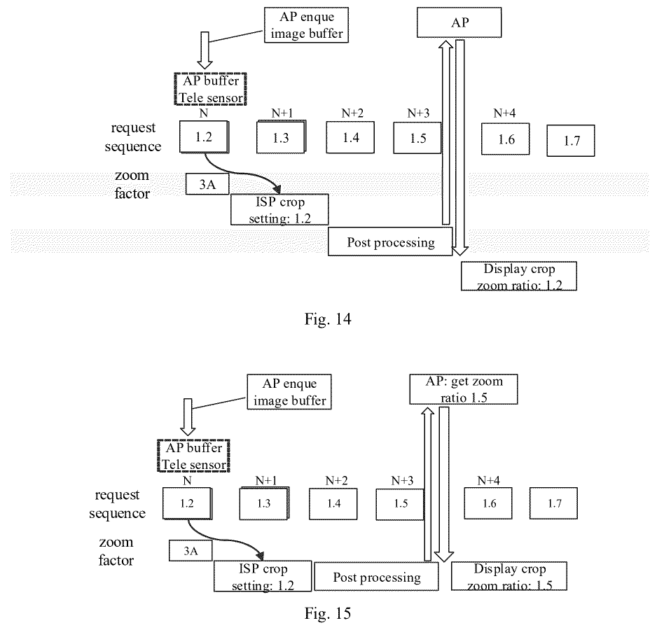

FIG. 14 illustrates a schematic diagram of the image display latency issue when a user continuously performs a zoom-in operation by sliding the zoom bar. As illustrated in FIG. 14: in a case where the user continuously conducts a zoom-in operation, the AP may continuously issue increasing zoom factors—for example, rising gradually from 1.2× at frame N to 1.6× at frame N+4 in the sequence. However, since the imaging device must go through a multi-step process (including 3A calculations imaging sensor exposure, ISP reading, and image post-processing) from configuring the imaging sensor to completing image display, the zoom factor matching with the image finally presented on the screen still remains at 1.2×. At this point, the user's finger has actually slid to the 1.6× zoom position. This significant lag between the “1.6× zoom factor matching with the user's operation” and the “1.2× zoom factor actually displayed on the screen” results in the displayed content failing to match the user's operation in real time. Consequently, the user perceives a noticeable operational delay, which may impair the user experience.

FIG. 15 illustrates a schematic diagram of the zoom method provided in an embodiment of the present disclosure in a case where the user continuously performs the zoom-in operation by sliding the zoom bar. Compared with FIG. 14, FIG. 15 adopts a phased cropping approach for the original image read from the imaging sensor. The user's zoom operation of FIG. 14 is identical to that of FIG. 15.

Specifically, in the scenario where the user continuously performs the zoom-in operation, since the FOV narrows as the zoom factor increases during zoom-in, the present technical solution first executes an initial cropping via the ISP, which may directly eliminate redundant image areas, thereby reducing the volume of image data to be processed in subsequent stages and effectively lowering device power consumption. The specific process is as follows: before the image is transmitted back to the AP, the ISP may complete the primary cropping based on the current zoom factor (e.g., the ISP performs cropping at a 1.2× zoom factor in FIG. 15); after the image is transmitted back to the AP, final cropping may be executed based on the latest zoom factor obtained by the AP (e.g., 1.5× in FIG. 15). This phased cropping design ensures that there is only a one-frame difference between the “zoom factor corresponding to the user's finger operation” and the “zoom factor of the finally displayed image,” significantly reducing the response lag between operation and display compared to the multi-frame delay in FIG. 14.

The advantages of the implementation illustrated in FIG. 15 may be mainly reflected in three aspects: 1, Power Consumption Optimization. The primary cropping may reduce the volume of data sources for subsequent image processing stages, lowering the image processing load of the imaging device and thus achieving effective control of overall power consumption; 2, Latency Reduction. Phased cropping makes the finally displayed image more aligned with the user's latest operation, compressing the response latency to a “one-frame difference” range and significantly improving operational response speed; and, 3, User Experience Enhancement: The time lag between the user's finger operation and the displayed content is controlled within a single frame, making the feedback of zoom operations smoother and more immediate, which greatly optimizes the user's operational experience.

### Implementation 2:

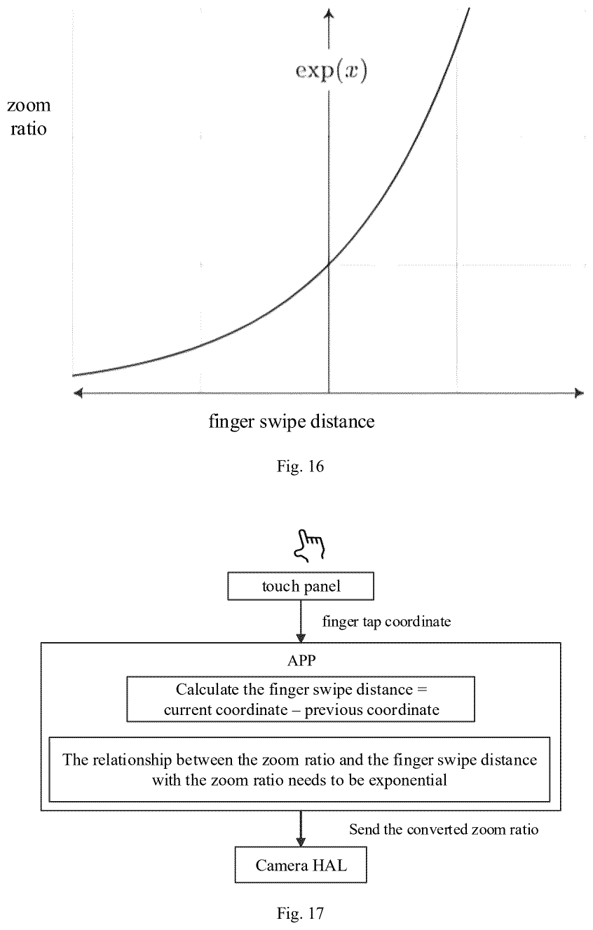

As illustrated in FIG. 16 and FIG. 17, FIG. 16 is a relationship curve diagram of finger swipe distance and zoom factor in the pinch-to-zoom scenario, and FIG. 17 is a processing flowchart for converting a user's finger pinch gesture into a zoom factor according to an embodiment of the present disclosure. Those skilled in the art would understand that, FIG. 16 and FIG. 17 are provided as examples without limitation to illustrate one implementation for obtaining a zoom factor from a user's gesture. The present disclosure does not limit users to using other gestures to indicate the zoom factor.

In FIG. 16, the horizontal axis corresponds to the finger swipe distance, and the vertical axis corresponds to the zoom factor. The relationship curve between the finger swipe distance and the zoom factor conforms to the variation characteristic of the exponential function ‘exp (x)’. As the finger swipe distance increases, the zoom factor may show an exponential growth trend that is “gentle in the early stage and rapidly rising in the later stage.”

FIG. 17 illustrates a complete processing flow from user touch operation to zoom factor generation. When the user touches the screen via a two-finger pinch operation, the touch panel may collect the position coordinates of the fingers in real time, and send them to the application program (APP). The APP may calculate the finger swipe distance “by subtracting the previous coordinates from the current coordinates. To achieve a uniform scaling effect that better aligns with the user's operational intuition, the system may map the finger swipe distance to the zoom factor according to the exponential relationship illustrated in FIG. 16. Based on the above exponential zoom rule, the APP may calculate the currently matched zoom factor and send it to the Camera HAL to support subsequent imaging processing.

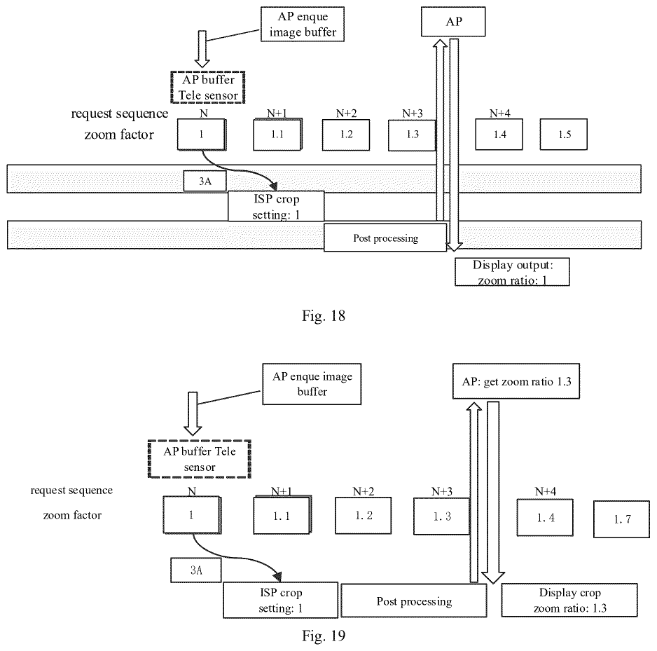

As illustrated in FIG. 18 and FIG. 19, FIG. 18 illustrates a schematic diagram of the image display latency issue when a user performs a zoom-in operation via pinch-to-zoom, FIG. 19 illustrates a schematic diagram of the zoom method provided according to an embodiment of the present disclosure when a user continuously performs a zoom-in operation via pinch-to-zoom. The user's zoom operation of FIG. 18 is identical to that of FIG. 19. When the user continuously conducts a zoom-in operation, the AP will continuously issue increasing zoom factors. For example, the zoom factor may rise gradually from 1× at frame N to 1.4× at frame N+4 in the sequence.

In FIG. 18, the scenario is similar to that of FIG. 14. Once the HAL layer receives the zoom request of the N frame, it may go through 3A calculations, sets the exposure parameters of the sensor, and performs image signal processing (ISP read out). After post-processing, the resulting YUV image is returned to the APP. Finally, the APP sends this image to the display for rendering. These operations accumulate to result in a total delay of at least 4 frames

In FIG. 19, similar to the scenario in FIG. 15, a phased cropping approach is adopted for the raw image read out from the imaging sensor. Before the image is transmitted back to the AP, the ISP completes primary cropping based on the current zoom factor (e.g., the ISP performs cropping at a 1× zoom factor in FIG. 19). After the image is transmitted back to the AP, final cropping is executed based on the latest zoom factor obtained by the AP (e.g., 1.3× in FIG. 19). This phased cropping design ensures that there is only a one-frame difference between the “zoom factor matching with the user's finger operation” and the “zoom factor of the finally displayed image,” significantly reducing the response lag between operation and display compared to the multi-frame delay in FIG. 18.

The present implementation directly applies the latest finger position changes to the upcoming display, resulting in only one frame of delay for the user. The advantage of the present implementation is that it may provide more immediate responses, especially in applications that require quick feedback. By reducing the delay, users can experience smoother and more instantaneous interactions.

Further refer to FIG. 1, an imaging device 100 may be provided in the present disclosure. The imaging device may include an imaging sensor 120, an image signal processor, an application processor, and a display module communicatively connected.

The application processor may be configured to: obtain a first zoom factor based on a user setting operation; and determine a zoom factor variable based on the first zoom factor and the user setting operation, to generate a second zoom factor. The imaging sensor may be configured to acquire a raw image. The image signal processor may be configured to: crop the raw image according to the second zoom factor to generate a first image. The application processor may be further configured to: acquire an updated first zoom factor; and in a case where an absolute value of a difference between the updated first zoom factor and the second zoom factor is greater than a preset value, crop the first image according to the updated first zoom factor to generate a second image. The display module may be configured to: display the second image.

For further details of these operations, reference may be made to the descriptions above.

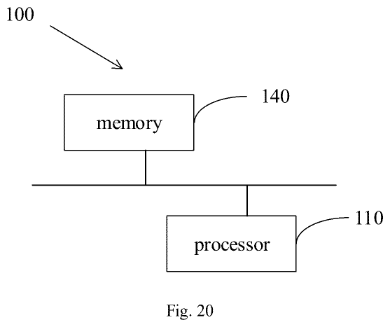

As illustrated in FIG. 20, FIG. 20 is a schematic structural diagram of an imaging device according to some embodiments of the present disclosure. As illustrated in FIG. 20, the imaging device may include a memory and a processor. The memory stores a program code. The program code, when executed by the processor, may enable the imaging device to perform the above-mentioned zoom method.

As discussed above, the zoom method may include: obtaining a first zoom factor based on a user setting operation; acquiring a raw image based on the first zoom factor; determining a zoom factor variable based on the first zoom factor and the user setting operation, to generate a second zoom factor; cropping the raw image according to the second zoom factor to generate a first image; acquiring an updated first zoom factor; in a case where an absolute value of a difference between the updated first zoom factor and the second zoom factor is greater than a preset value, cropping the first image according to the updated first zoom factor to generate a second image; and displaying the second image. For further details of these operations, reference may be made to the descriptions above.

The present disclosure provides a new crop method to optimize zoom responsiveness by: performing cropping at the final stage, cropping the image at the final stage of processing to ensure the best image quality and accuracy; and, dynamically placing image margins based on predicted finger positions. The system may dynamically adjust the image margins based on the predicted finger positions to ensure that there is still enough FOV for cropping at the final stage.

The present disclosure provides a new image processing method aimed at enhancing the user experience during zoom operations while also conserving device power consumption. Specifically, when the AP sends a zoom request, the software process, in addition to performing the usual controls, needs to predict the zoom direction of the user based on historical zoom factor records. If the system determines that the user is continuously zooming in, to save power, the imaging device may crop the image based on the latest zoom factor. This may reduce unnecessary image processing, thereby lowering power consumption. Conversely, if the system determines that the user is zooming out, to provide a better responsiveness and clarity experience, the device will dynamically adjust the crop size of the zoomed image. This ensures that during the zoom-out process, the image clarity and smoothness are not compromised. When the AP receives the image output from the camera, it will perform the final cropping based on the current zoom factor (i.e., the user's last finger position) before displaying it on the screen. This way, the final cropping of the image occurs at the last stage before display, maintaining image clarity and avoiding excessive power consumption due to large image sizes. In summary, the present disclosure achieves the goal of maintaining image clarity while effectively saving power during the zoom process by intelligently predicting the user's zoom direction and dynamically adjusting the image crop size.

### Exception Conditions

If switching perspectives are involved, e.g., switching from one perspective to another, the present method may not gain the benefits.

If switching sensor modes are required, e.g., switching from one sensing mode to another, the present method may not gain the benefits.

### Way to Prove Infringement

According to the description of Google Android U version, the latency at the HAL layer is approximately 165 ms, and the APP latency is about 75 ms. Therefore, if the latency of an imaging device is around 75 ms, it indicates that it may also performing cropping on the display side, leading to a reasonable suspicion that the same method as this patent is being used.

If the integrated units in the above-mentioned other embodiments are implemented in the form of software functional units and sold or used as independent product, then they could be stored in a computer-readable storage medium. Based on such kind of understanding, the technical solution of the present disclosure essentially or a part contributing to the prior art or part or all of the technical solution may be embodied in the form of software products. The computer software products may be stored in one storage medium. The computer software products may include some instructions for causing a computer device (which may be a personal computer, a server or a network device, etc.) or a processor to implement all or part of the operations of the methods described in various embodiments of the present disclosure. The afore-mentioned storage medium may include: U disk, mobile hard disk drive, read-only memory (ROM), random access memory (RAM), magnetic disk or CD-ROM and other media that can store program codes.

The above are only implementations of the present disclosure, and do not limit the patent scope of the present disclosure. Any equivalent changes to the structure or processes made by the description and drawings of this application or directly or indirectly used in other related technical field are included in the protection scope of this application.

What is claimed is:

1. A zoom method for an imaging device, comprising:
obtaining a first zoom factor based on a user setting operation;
acquiring a raw image; determining a zoom factor variable based on the first zoom factor and the user setting operation, to generate a second zoom factor;
cropping the raw image according to the second zoom factor to generate a first image;
acquiring an updated first zoom factor;
in a case where an absolute value of a difference between the updated first zoom factor and the second zoom factor is greater than a preset value, cropping the first image according to the updated first zoom factor to generate a second image; and
displaying the second image.

2. The method as claimed in claim 1, wherein
the user setting operation comprises any one of rotating a screen dial, sliding a zoom factor bar, or a gesture operation.

3. The method as claimed in claim 1, wherein
the determining the zoom factor variable based on the first zoom factor and the user setting operation to generate the second zoom factor comprises:
analyzing, based on the first zoom factor and a plurality of historical first zoom factors corresponding to historical user setting operations, a change trend of the first zoom factor over time, to determine a zoom direction;
determining the zoom factor variable according to the zoom direction; and
subtracting the zoom factor variable from the first zoom factor to generate the second zoom factor.

4. The method as claimed in claim 3, wherein
the analyzing, based on the first zoom factor and the plurality of historical first zoom factors, the change trend of the first zoom factor over time, to determine the zoom direction comprises:
acquiring a zoom factor sequence, wherein the zoom factor sequence comprises the first zoom factor and the plurality of historical first zoom factors arranged in chronological order;
calculating a difference between every two adjacent zoom factors in the zoom factor sequence to obtain a difference sequence; and
analyzing a change trend of the difference sequence to determine the zoom direction.

5. The method as claimed in claim 4, wherein
the analyzing the change trend of the difference sequence to determine the zoom direction comprises:
in a case where differences in the difference sequence are positive and an absolute values of the differences increase or remain unchanged, determining the zoom direction as continuous zoom-in; and/or
in a case where differences in the difference sequence are negative and the absolute values of the differences increase or remain unchanged, determining the zoom direction as continuous zoom-out; and/or
in a case where the absolute values of the differences in the difference sequence gradually decreases or become zero, determining the zoom direction as a potential direction change.

6. The method as claimed in claim 5, wherein
the determining the zoom factor variable according to the zoom direction comprises at least one of:
in a case where the zoom direction is the continuous zoom-in, determining the zoom factor variable as a first variable;
in a case where the zoom direction is the continuous zoom-out, determining the zoom factor variable as a second variable; and/or
in a case where the zoom direction is the potential direction change, determining the zoom factor variable as a third variable,
wherein the first variable is less than the third variable, and the third variable is less than the second variable.

7. The method as claimed in claim 6, wherein
the first variable is 0; and/or
the second variable is 0.3; and/or
the third variable is 0.1.

8. The method as claimed in claim 1, wherein
the imaging device comprises an image signal processor (ISP);
the cropping the raw image according to the second zoom factor to generate the first image comprises:
cropping, by the ISP, the raw image according to the second zoom factor to generate the first image.

9. The method as claimed in claim 8, wherein
the imaging device further comprises an application processor (AP);
the cropping the first image according to the updated first zoom factor to generate the second image comprises:
cropping, by the AP, the first image according to the updated first zoom factor to generate the second image.

10. The method as claimed in claim 1, wherein
the imaging device further comprises a display module;
the displaying the second image comprises:
displaying the second image via the display module.

11. An imaging device, comprising an imaging sensor, an image signal processor, an application processor, and a display module communicatively connected, wherein
the application processor is configured to: obtain a first zoom factor based on a user setting operation; and determine a zoom factor variable based on the first zoom factor and the user setting operation, to generate a second zoom factor;
the imaging sensor is configured to acquire a raw image;
the image signal processor is configured to: crop the raw image according to the second zoom factor to generate a first image;
the application processor is further configured to: acquire an updated first zoom factor; and in a case where an absolute value of a difference between the updated first zoom factor and the second zoom factor is greater than a preset value, crop the first image according to the updated first zoom factor to generate a second image; and
the display module is configured to: display the second image.

12. The imaging device as claimed in claim 11, wherein
the determining the zoom factor variable based on the first zoom factor and the user setting operation to generate the second zoom factor comprises:
analyzing, based on the first zoom factor and a plurality of historical first zoom factors corresponding to historical user setting operations, a change trend of the first zoom factor over time, to determine a zoom direction;
determining the zoom factor variable according to the zoom direction; and
subtracting the zoom factor variable from the first zoom factor to generate the second zoom factor.

13. The imaging device as claimed in claim 12, wherein
the analyzing, based on the first zoom factor and the plurality of historical first zoom factors, the change trend of the first zoom factor over time, to determine the zoom direction comprises:
acquiring a zoom factor sequence, wherein the zoom factor sequence comprises the first zoom factor and the plurality of historical first zoom factors arranged in chronological order;
calculating a difference between every two adjacent zoom factors in the zoom factor sequence to obtain a difference sequence; and
analyzing a change trend of the difference sequence to determine the zoom direction.

14. The imaging device as claimed in claim 13, wherein
the analyzing the change trend of the difference sequence to determine the zoom direction comprises:
in a case where differences in the difference sequence are positive and an absolute values of the differences increase or remain unchanged, determining the zoom direction as continuous zoom-in; and/or
in a case where differences in the difference sequence are negative and the absolute values of the differences increase or remain unchanged, determining the zoom direction as continuous zoom-out; and/or
in a case where the absolute values of the differences in the difference sequence gradually decreases or become zero, determining the zoom direction as a potential direction change.

15. The imaging device as claimed in claim 14, wherein
the determining the zoom factor variable according to the zoom direction comprises at least one of:
in a case where the zoom direction is the continuous zoom-in, determining the zoom factor variable as a first variable;
in a case where the zoom direction is the continuous zoom-out, determining the zoom factor variable as a second variable; and/or
in a case where the zoom direction is the potential direction change, determining the zoom factor variable as a third variable,
wherein the first variable is less than the third variable, and the third variable is less than the second variable.

16. The imaging device as claimed in claim 15, wherein
the first variable is 0; and/or
the second variable is 0.3; and/or
the third variable is 0.1.

17. An imaging device, comprising a memory and a processor, the memory storing a program code, wherein
the program code, when executed by the processor, enables the imaging device to perform a zoom method comprising:
obtaining a first zoom factor based on a user setting operation;
acquiring a raw image; determining a zoom factor variable based on the first zoom factor and the user setting operation, to generate a second zoom factor;
cropping the raw image according to the second zoom factor to generate a first image;
acquiring an updated first zoom factor;
in a case where an absolute value of a difference between the updated first zoom factor and the second zoom factor is greater than a preset value, cropping the first image according to the updated first zoom factor to generate a second image; and
displaying the second image.

18. The imaging device as claimed in claim 17, wherein
the determining the zoom factor variable based on the first zoom factor and the user setting operation to generate the second zoom factor comprises:
analyzing, based on the first zoom factor and a plurality of historical first zoom factors corresponding to historical user setting operations, a change trend of the first zoom factor over time, to determine a zoom direction;
determining the zoom factor variable according to the zoom direction; and
subtracting the zoom factor variable from the first zoom factor to generate the second zoom factor.

19. The imaging device as claimed in claim 18, wherein
the analyzing, based on the first zoom factor and the plurality of historical first zoom factors, the change trend of the first zoom factor over time, to determine the zoom direction comprises:
acquiring a zoom factor sequence, wherein the zoom factor sequence comprises the first zoom factor and the plurality of historical first zoom factors arranged in chronological order;
calculating a difference between every two adjacent zoom factors in the zoom factor sequence to obtain a difference sequence; and
analyzing a change trend of the difference sequence to determine the zoom direction.

20. The imaging device as claimed in claim 19, wherein
the analyzing the change trend of the difference sequence to determine the zoom direction comprises:
in a case where differences in the difference sequence are positive and an absolute values of the differences increase or remain unchanged, determining the zoom direction as continuous zoom-in; and/or
in a case where differences in the difference sequence are negative and the absolute values of the differences increase or remain unchanged, determining the zoom direction as continuous zoom-out; and/or
in a case where the absolute values of the differences in the difference sequence gradually decreases or become zero, determining the zoom direction as a potential direction change.
